(19) United States
(12) Patent Application Publication
(10) Pub. No.: US 2022/0154620 A1
(43) Pub. Date: May 19, 2022

(54) SELECTIVE REDUCING CATALYST FOR DIESELS AND DIESEL EXHAUST GAS PURIFICATION APPARATUS

(71) Applicant: N.E. CHEMCAT CORPORATION, Minato-ku (JP)

(72) Inventors: Kazunori KUMAMOTO, Minato-ku (JP); Takashi HIHARA, Minato-ku (JP)

(73) Assignee: N.E. CHEMCAT CORPORATION, Minato-ku (JP)

(21) Appl. No.: 17/440,471

(22) PCT Filed: Mar. 25, 2020
(86) PCT No.: PCT/JP2020/013356

§ 371 Date: Sep. 17, 2021

(30) Foreign Application Priority Data
Mar. 27, 2019 (JP) 2019-061659

(51) Int. Cl. F01N 3/20; B01J 29/72

(52) U.S. Cl. CPC F01N 3/2066; F01N 2570/14; F01N 2610/02; B01J 29/72

(57) ABSTRACT

Provided are a selective reducing catalyst for diesels and a diesel exhaust gas purification apparatus in which deterioration of NOₓ removal performance due to phosphorus poisoning is less likely to occur.

The selective reducing catalyst for diesels is arranged in a diesel engine, adsorbs ammonia and brings the ammonia into contact with nitrogen oxides in an exhaust gas discharged from a diesel engine to perform reduction, the selective reducing catalyst comprises: a catalyst carrier; a catalyst region provided on at least the catalyst carrier; and a phosphorus trapping region provided on at least the catalyst region, wherein the catalyst region comprises one or more selected from the group consisting of a zeolite-based catalyst containing at least zeolite and a transition metal element supported on the zeolite, a W—Ce—Zr composite oxide-based catalyst, and a vanadium-based catalyst, and the phosphorus trapping region comprises at least one or more selected from the group consisting of alumina and a rare earth-based basic oxide.

### TECHNICAL FIELD

The present invention relates to a selective reducing catalyst for diesels and a diesel exhaust gas purification apparatus.

### BACKGROUND ART

Regulations on emissions of nitrogen oxides (hereinafter, also referred to as “NOₓ”) have become stricter year by year. Particularly, in recent years, the tighter regulations on emissions of NOₓ discharged from diesel engines have required further improvement of NOₓ removal performance.

Selective catalytic reduction (hereinafter, also referred to as “SCR”) systems are used as a technique for removing NOₓ in an exhaust gas discharged from the diesel engine. In the SCR system, NOₓ in the exhaust gas is reduced to nitrogen, water and the like by a catalyst. For example, in a urea SCR system, ammonia (urea) is used as a reducing agent, and nitrogen oxides in an exhaust gas discharged from a diesel engine is brought into contact with the ammonia to perform reduction, thereby converting NOₓ into a harmless substance such as nitrogen. In recent years, development of SCR systems in which ammonia (urea) is not used as a reducing agent has been progressing.

As catalysts used in SCR systems, SSZ-13 which is of aluminosilicate type and has a small Al content and SAPO-34 which is of silico-aluminophosphate type are known, and have been studied extensively for responding to tighter regulations on exhaust gas from diesel cars. For example, for SSZ-13 containing Cu, impacts on catalytic activity by poisoning from phosphorus has been reported (see, for example, Non Patent Literatures 1 to 3).

### CITATION LIST

### Non Patent Literature

Non Patent Literature 1: Applied catalysis B: Environmental, Volumes 154-155, July-August 2014, Pages 339-349
Non Patent Literature 2: Catalysis Today, Volume 297, 15 Nov. 2017, Pages 46-52
Non Patent Literature 3: Applied Catalysis B: Environmental, Volume 241, February 2019, Pages 205-216

### SUMMARY OF INVENTION

### Technical Problem

In a diesel engine, ignition is performed by spraying a liquid fuel to air compressed and heated by a piston, and therefore the concentration of oxygen in an exhaust gas is high. Thus, in conventional exhaust gas purification systems, it is common that an oxidation catalyst (hereinafter, also referred to as DOC) for oxidizing HC and CO is provided, and a selective reducing catalyst for reducing NOₓ is provided at the rear of the oxidation catalyst. If necessary, a unit for supplying a reducing agent such as ammonia is provided on the upstream side of the selective reducing catalyst from the viewpoint of improving NOₓ reducing performance.

However, such conventional exhaust gas purification systems have a problem that the temperature of an exhaust gas decreases before the exhaust gas reaches the selective reducing catalyst. Since NOₓ reducing performance of the selective reducing catalyst is highly dependent on the temperature, the configuration in which the selective reducing catalyst is provided at the rear of the oxidation catalyst (DOC) is not enough to improve NOₓ reducing performance.

Thus, studies have been conducted on arranging the selective reducing catalyst at a position immediately below the diesel engine. The results thereof have showed that when the selective reducing catalyst is arranged at a position immediately below the diesel engine, the placement of the selective reducing catalyst is expected to improve the NOₓ removal performance of the system. On the other hand, there has been a concern that the performance is deteriorated more significantly as compared to a case where the selective reducing catalyst is arranged at a conventional position. Studies further conducted on this have come to reveal that the deterioration of the catalyst performance is due to poisoning of the catalyst by phosphorus derived from engine oil, etc. It is considered that conventionally, the selective reducing catalyst is provided at the rear of an oxidation catalyst (DOC) or a catalyzed soot filter (CSF) is provided, and therefore slipping of a poisoning component to the downstream is suppressed particularly by a filter catalyst. It is considered that for this reason, such deterioration of NOₓ removal performance due to phosphorus poisoning is not a serious problem in the conventional arrangement of the catalyst.

The present invention has been made in view of the above-described problems, and an object of the present invention is to provide a selective reducing catalyst for diesels and a diesel exhaust gas purification apparatus in which deterioration of NOₓ removal performance due to phosphorus poisoning is less likely to occur. The object is not limited thereto, and exhibition of effects which are derived by the configurations shown in “Description of Embodiment” below and which cannot be obtained by conventional techniques can be taken as another object of the present invention.

### Solution to Problem

The present inventors have extensively conducted studies on a method for suppressing deterioration of NOₓ removal performance due to phosphorus poisoning. As a result, it has been found that the above-described problems can be solved by forming a phosphorus trapping region on a catalyst region, leading to completion of the present invention.

That is, the present invention provides various specific aspects shown below.

[1]

A selective reducing catalyst for diesels which is arranged in a diesel engine, adsorbs ammonia and brings the ammonia into contact with nitrogen oxides in an exhaust gas discharged from a diesel engine to perform reduction, the selective reducing catalyst comprising:

a catalyst carrier;

a catalyst region provided on at least the catalyst carrier; and

a phosphorus trapping region provided on at least the catalyst region,

wherein the catalyst region comprises one or more selected from the group consisting of a zeolite-based catalyst containing at least zeolite and a transition metal element supported on the zeolite, a composite oxide-based catalyst containing W, and a vanadium-based catalyst, and the phosphorus trapping region comprises at least one or more selected from the group consisting of alumina and a rare earth-based basic oxide.

[2]

The selective reducing catalyst for diesels according to [1], wherein the phosphorus trapping region is substantially free of a platinum element.

[3]

The selective reducing catalyst for diesels according to [1] or [2], wherein the amount of the phosphorus trapping region supported per L of the catalyst carrier is 20 g/L or more.

[4]

The selective reducing catalyst for diesels according to any one of [1] to [3], wherein the phosphorus trapping region comprises particles having a particle diameter D₉₀ of 5.0 μm to 35 μm.

[5]

The selective reducing catalyst for diesels according to any one of [1] to [4], wherein the transition metal element comprises at least one or more selected from the group consisting of Cu, Fe, Ce, Mn, Ni, Co, Ag, Rh, Ru, Pd, Ir and Re.

[6]

The selective reducing catalyst for diesels according to any one of [1] to [5], wherein the zeolite is zeolite having an oxygen six-membered ring structure, an oxygen double six-membered ring structure, an oxygen eight-membered ring structure and/or an oxygen twelve-membered ring structure.

[7]

The selective reducing catalyst for diesels according to any one of [1] to [6], wherein the zeolite is one or more selected from the group consisting of CHA, AEI, AFX, KFI, SFW, MFI and BEA.

[8]

The selective reducing catalyst for diesels according to any one of [1] to [7], wherein the catalyst carrier is a flow-through type catalyst carrier.

[9]

The selective reducing catalyst for diesels according to any one of [1] to [8], wherein the amount of the catalyst region supported per L of the catalyst carrier is 100 g/L or more.

[10]

A diesel exhaust gas purification apparatus, comprising at least:

a selective reducing catalyst which adsorbs ammonia and brings the ammonia into contact with nitrogen oxides in an exhaust gas discharged from a diesel engine to perform reduction; and

one or more oxidation catalysts which oxidize at least one selected from the group consisting of CO, HC, NO and NH₃ discharged from the diesel engine,

wherein the selective reducing catalyst is a selective reducing catalyst for diesels according to any one of [1] to [9], and

the selective reducing catalyst is arranged on the upstream side of the exhaust gas flow channel with respect to the oxidation catalyst so that the exhaust gas contacts the selective reducing catalyst and the oxidation catalyst in this order.

### Advantageous Effects of Invention

According to the present invention, it is possible to provide a selective reducing catalyst and a diesel exhaust gas purification apparatus in which deterioration of NOₓ removal performance due to phosphorus poisoning is less likely to occur.

### BRIEF DESCRIPTION OF DRAWINGS

FIG. 1 is a schematic view showing a general configuration of a diesel exhaust gas purification apparatus 100 comprising a selective reducing catalyst for diesels according to an embodiment.

FIG. 2 is a graph showing the results of pressure loss tests in Examples.

FIG. 3 is a photograph showing the results of measurement with an electron probe micro analyzer (EPMA) for the catalyst samples of Example 3 and Comparative Example 1. P: phosphorus, CP: component image

### DESCRIPTION OF EMBODIMENT

Hereinafter, an embodiment of the present invention will be described in detail. The following embodiment is one example (typical example) of the embodiments of the present invention, which should not be construed as limiting the present invention. The present invention can be carried out with any change made without departing from the spirit thereof. In the present description, Relative positions such as the upper, the lower, the left and the right are based on the relative positions shown in the drawings unless otherwise specified. The dimensional ratios in the drawings are not limited to the ratios shown in the drawings.

In the present description, a range of numerical values or physical property values described before and after the term “to” includes the values before and after the term. For example, the representation of the numerical range of “1 to 100” includes both the lower limit value “1” and the upper limit value “100”. The same applies to the representations of other numerical ranges.

Further, in the present description, the term “average particle diameter D₅₀” refers to a particle diameter at which the integrated value at smaller particle diameters reach 50% of the total in a cumulative distribution of particle diameters on a volume basis. The “average particle diameter D₅₀” means a so-called median diameter, which is a value obtained by performing measurement with a laser diffraction particle diameter distribution measuring apparatus (e.g. Laser Diffraction Particle Diameter Distribution Measuring Apparatus SALD-3100 manufactured by Shimadzu Corporation). The “particle diameter D₉₀” refers to a particle diameter at which the integrated value at smaller particle diameters reach 90% of the total in a cumulative distribution of particle diameters on a volume basis.

The BET specific surface area is a value determined by a BET one-point method using a specific surface area/pore distribution measuring apparatus (product name: BELSORP-minill manufactured by MicrotracBell Corp.) and analysis software (product name: BEL Master manufactured by MicrotracBell Corp.).

### [Exhaust Gas Purification Catalyst]

Selective reducing catalysts for diesels according to the present embodiment are catalysts which are arranged in a diesel engine and which adsorb ammonia and bring the ammonia into contact with nitrogen oxides in an exhaust gas discharged from the diesel engine to perform reduction. Of these, the selective reducing catalyst arranged immediately below the diesel engine is also referred to as a closed-coupled SCR catalyst (cc-SCR catalyst). The term “position immediately below” refers to a catalyst present at the downstream of the engine and immediately behind the engine. Therefore, when between the engine and a catalyst, another catalyst is placed, the former catalyst is not present immediately below the engine. The catalyst present at the downstream of the engine and immediately behind the engine can be referred to as a catalyst arranged immediately below the engine even when a structure such as a pipe is present between the engine and the catalyst.

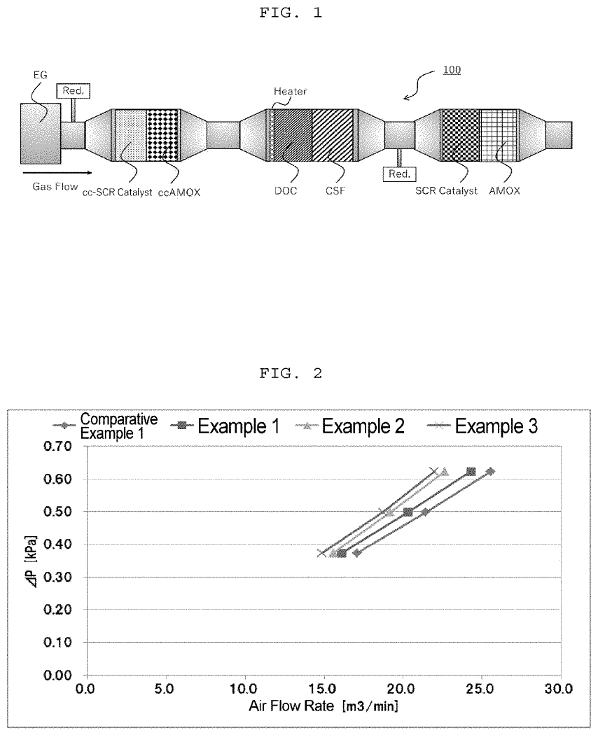

FIG. 1 shows a diesel exhaust gas purification apparatus 100 comprising the selective reducing catalyst for diesels (cc-SCR catalyst) according to the present embodiment. The diesel exhaust gas purification apparatus 100 comprises at least: a selective reducing catalyst for diesels (cc-SCR catalyst); an ammonia oxidation catalyst (cc-AMOX) for oxidizing and removing excess ammonia; one or more oxidation catalysts (DOC) for oxidizing at least one or more selected from the group consisting of CO, HC, NO and NH₃ in an exhaust discharged from a diesel engine; a catalyzed soot filter (CSF) with a catalyst supported on a diesel particulate filter (DPF); one or more selective reducing catalysts (SCR catalyst) which adsorbs ammonia and bringing the ammonia into contact with NOₓ to perform reduction; and an ammonia oxidation catalyst (AMOX), in this order from the engine (EG) side. In the present embodiment, the “selective reducing catalyst” and the “selective reducing catalyst for diesels” are precisely distinguished from each other, and the “selective reducing catalyst for diesels” is not abbreviated as the “selective reducing catalyst”.

In the present embodiment, the selective reducing catalyst for diesels for reducing NOₓ in an exhaust gas with ammonia as a reducing agent and the oxidation catalyst for oxidizing CO, HC, NO, NH₃ and the like in the exhaust gas are provided in this order from the upstream side to the downstream side of an exhaust gas flow channel. In addition, at the rear of the oxidation catalyst, a selective reducing catalyst which adsorbs ammonia and brings the ammonia into contact with nitrogen oxides in the exhaust gas discharged from the diesel engine to perform reduction, and an ammonia oxidation catalyst (AMOX) for oxidizing and removing excess ammonia are provided. Further, a plasma generating apparatus PI. etc. for plasma-treating the exhaust gas may be provided (not shown).

Further, it is preferable that in the diesel exhaust gas purification apparatus 100, the reducing agent supplying unit Red. for supplying a urea component, an ammonia component and the like be provided on the upstream side with respect to the selective reducing catalyst for diesels and the selective reducing catalyst.

By arranging the selective reducing catalyst for diesels on the upstream side of the exhaust gas flow channel with respect to the oxidation catalyst so that the exhaust gas discharged from the diesel engine contacts the selective reducing catalyst for diesels and the oxidation catalyst in this order, a relatively high-temperature exhaust gas is supplied to the selective reducing catalyst for diesels. This enables improvement of NOₓ removal performance of the selective reducing catalyst for diesels.

### (Catalyst Configuration)

Hereinafter, the catalyst configuration of the selective reducing catalyst for diesels according to the present embodiment will be described.

The selective reducing catalyst for diesels according to the present embodiment comprises a catalyst carrier, a catalyst region provided on at least the catalyst carrier, and a phosphorus trapping region provided on at least the catalyst region. From the viewpoint of efficiently catching phosphorus and suppressing phosphorus poisoning of the catalyst region, it is preferable that the phosphorus trapping region be layered so as to cover the catalyst region.

### (Catalyst Carrier)

As the integral structure type catalyst carrier supporting the catalyst region, for example, honeycomb structures commonly used for automobile exhaust applications are preferably used. Examples of such honeycomb structures include ceramic monolith carriers such as cordierite, silicon carbide and silicon nitrite, metal honeycomb carriers made of stainless steel or the like, wire mesh carriers made of stainless steel or the like, and steel wool-shaped knitted wire carriers. The shape thereof is not particularly limited, and one having any shape such as, for example, a prismatic column shape, a cylindrical shape, a spherical shape, a honeycomb shape or a sheet shape can be selected. One of these honeycomb structures can be used, or two or more thereof can be appropriately combined and used. As the honeycomb structure for automobile exhaust gas applications, flow-through type catalyst carriers in which gas flow channels communicate with one another can be used.

### (Catalyst Region)

The catalyst region is a region involved in removal of NOₓ, and includes one or more selected from the group consisting of zeolite-based catalysts containing at least zeolite and a transition metal element supported on the zeolite, composite oxide-based catalysts containing W and vanadium-based catalysts.

The range over which the catalyst region is formed is not particularly limited, and the catalyst region may be formed over the entire catalyst carrier in the exhaust gas flow direction, or may be formed on some regions of the catalyst carrier in the exhaust gas flow direction. When the catalyst region is formed on some regions of the catalyst carrier in the exhaust gas flow direction, it is preferable that the catalyst region be formed on the downstream side of the catalyst carrier in the exhaust gas flow direction. When the catalyst region is formed on some regions of the catalyst carrier, other regions of the catalyst carrier may be provided with other catalyst regions.

The catalyst region may have one catalyst layer or two or more different catalyst layers on the catalyst carrier. Here, the different catalyst layers are those different in metal species or combinations of metal species which form the catalyst.

As zeolite forming the zeolite-based catalyst, various kinds of zeolite heretofore used in selective reducing catalysts can be considered. The zeolite mentioned here includes alumino silicate, and crystal metal aluminophosphates having micropores and having a layered structure similar to that of zeolite, such as alumino phosphate (ALPO) and crystal silica-alumino phosphate (SAPO). Specific examples thereof include, but are not particularly limited to, those that are so called alumino-phosphate such as SAPO-34 and SAPO-18.

Specific examples of the zeolite used here include, but are not particularly limited to, zeolites of Y type, A type, L type, beta type, mordenite type, ZSM-5 type, ferrierite type, mordenite type, CHA type, AEI type, AFX type, KFI type and SFW type, and crystal metal aluminophosphates such as SAPO and ALPO. One of these zeolites can be used, or two or more thereof can be used in any combination and ratio.

The skeletal structures of zeolites are stored in a database by International Zeolite Association, hereinafter sometimes abbreviated as “IZA”), and zeolites specified in the IUPAC structure code (hereinafter, also referred to simply as the “structure code”) can be used without particular limitation. Their structures can be identified by comparison with powder X-ray diffraction (hereinafter, referred to as “XRD”) patterns described in Collection of simulated XRD powder patterns for zeolites, Fifth revised edition (2007) or XRD patterns described in Zeolite Framework Types of the IZA Structure Committee website: http://www.iza-structure.org/databases/. Of these, zeolites having heat resistance and various known skeletal structures can be used.

Of these zeolites, zeolites having an oxygen six-membered ring structure, an oxygen double six-membered ring structure, an oxygen eight-membered ring structure and/or an oxygen twelve-membered ring structure are preferable, zeolites having an oxygen six-membered ring structure, an oxygen double six-membered ring structure or an oxygen eight-membered ring structure are more preferable, and zeolites having an oxygen six-membered ring structure or an oxygen double six-membered ring structure are still more preferable. Specifically, zeolites having one or more skeletal structures selected from the group consisting of CHA, AEI, AFX, KFI, SFW, MFI and BEA are more preferable, and zeolites having one or more skeletal structures selected from the group consisting of CHA, AEI, AFX, KFI and SFW are still more preferable. In zeolite, the number of acid points varies depending on a Si/Al ratio. In general, zeolite having a low Si/Al ratio has a large number of acid points, but is degraded to a large extent in the context of durability in coexistence of water vapor, whereas zeolite having a high Si/Al ratio is excellent in heat resistance, but tends to have a small number of acid points. From such a viewpoint, the Si/Al ratio of zeolite used is preferably 1 to 500, more preferably 1 to 100, still more preferably 1 to 50.

The average particle diameter D₅₀ of the zeolite in the catalyst region can be appropriately set depending on desired performance, and is not particularly limited. From the viewpoint of maintaining a large specific surface area and enhancing heat resistance to increase the number of their own catalytically active sites, the average particle diameter D₅₀ of the zeolite is preferably 0.5 to 100 μm, more preferably 0.5 to 50 μm, still more preferably 0.5 to 30 μm. The BET specific surface area of the zeolite can be appropriately set depending on desired performance, and is not particularly limited, and from the viewpoint of maintaining a large specific surface area and enhancing catalytic activity, the BET specific surface area by the BET one-point method is preferably 10 to 1000 m²/g, more preferably 50 to 1000 m²/g, still more preferably 100 to 1000 m²/g. A large number of zeolites of various grades are commercially available from domestic and foreign manufacturers.

Examples of the transition metal element contained in the catalyst region include, but are not limited to, copper (Cu), iron (Fe), cerium (Ce), manganese (Mn), nickel (Ni), cobalt (Co), silver (Ag), ruthenium (Rh), rhodium (Ru), palladium (Pd), iridium (Ir) and rhenium (Re). Of these, copper, iron, manganese, nickel, cobalt and rhenium are preferable, copper, iron, manganese, nickel and cobalt are more preferable, and copper and iron are still more preferable. The transition metal element may be dispersively held in the catalyst region, and is preferably supported on the surface of the zeolite. One of the transition metal elements can be used, or two or more thereof can be used in any combination and ratio.

In general, as solid acid points, cations are present as counter ions in zeolite, and the cation is generally an ammonium ion or a proton. In the present embodiment, it is preferable to use zeolite as transition metal element ion-exchange zeolite in which cation sites of the zeolite are ion-exchanged with any of these transition metal elements. The ion-exchange rate of the zeolite is not particularly limited, and is preferably 1 to 100%, more preferably 10 to 95%, still more preferably 30 to 90%. An ion-exchange rate of 100% means that all of cationic species in the zeolite are ion-exchanged with transition metal element ions.

The amount of Cu or Fe added with respect to the zeolite is preferably 0.1 to 10 wt %, more preferably 1 to 10 wt %, still more preferably 2 to 8 wt %, in terms of oxide (CuO or Fe₂O₃). All of the transition metal elements added as ion-exchange species may be ion-exchanged, or some of the transition metal elements may be present in the form of an oxide such as copper oxide or iron oxide. From the viewpoint of improving exhaust gas purification performance, etc., the content ratio of transition metal element ion-exchange zeolite ion-exchanged with any of these transition metal elements (mass of the transition metal element per L of the integral structure type catalyst carrier) is, normally, preferably 0.1 to 50 g/L, more preferably 1 to 30 g/L, still more preferably 2 to 15 g/L in terms of oxide of the transition metal element.

As the catalyst region, catalysts are preferably used in which a SCR layer containing ion-exchange zeolite ion-exchanged with at least one transition metal element selected from the group consisting of nickel, cobalt, copper, iron and manganese is provided on an integral structure type catalyst carrier such as honeycomb structure. Of these, Cu ion-exchange zeolite and Fe ion-exchange zeolite are particularly preferably used. A configuration in which a SCR layer containing a zeolite-based catalyst material as mentioned above is provided on the catalyst carrier enables achievement of high exhaust gas purification performance while inhibiting an increase in pressure loss.

The composite oxide-based catalyst containing W is not particularly limited as long as it is a composite oxide containing tungsten, a W—Ce—Zr composite oxide containing tungsten, ceria and zirconia is preferable, and other components such as silica may be contained if necessary. Here, tungsten contributes to adsorption of urea and ammonia which are alkali components, ceria contributes to adsorption of NOₓ, and can promote the SCR reaction of NH₃ and NO_{N}, and zirconia can contribute as a dispersion holding material for highly dispersing other components in a thermally stable state.

Examples of the vanadium-based catalyst include catalysts having at least vanadium oxide supported on a carrier. The carrier is not particularly limited, and examples thereof include titanium oxide and zeolite.

Here, the catalyst region may contain an oxygen storage and release material such as a ceria-based oxide or a ceria-zirconia-based composite oxide and other base material particles as long as the effects of the present invention are excessively inhibited. As the oxygen storage and release material, an inorganic compound heretofore used in this type of exhaust gas purifying catalyst can be considered. Specifically, ceria-based oxides and ceria-zirconia-based composite oxides having not only an excellent oxygen storage capacity but also relatively excellent heat resistance are preferably used as oxygen storage and release materials.

Examples of other base material particles include inorganic compounds known in the art, for example, oxides such as aluminum oxides (alumina: Al₂O₃) such as γ-alumina, β-alumina, δ-alumina, η-alumina and θ-alumina, zirconium oxide (zirconia: ZrO₂), silicon oxide (silica: SiO₂) and titanium oxide (titania: TiO₂), and composite oxides containing any of these oxides as a main component, and the type thereof is not particularly limited. They may be composite oxides or solid solutions containing a rare earth element such as lanthanum or yttrium, a transition metal element or an alkaline earth metal. One type of these oxygen storage and release materials and other base material particles can be used, or two or more thereof can be used in any combination and ratio.

The catalyst region may contain various other catalyst materials and co-catalyst known in the art and various additives. The catalyst region may contain binders such as a variety of sols such as, for example, boehmite, alumina sol, titania sol, silica sol and zirconia sol; and soluble salts such as aluminum nitrate, aluminum acetate, titanium nitrate, titanium acetate, zirconium nitrate and zirconium acetate. The catalyst region may further contain a Ba-containing compound in addition to the above-described components. Further, the catalyst region may contain a dispersion stabilizer such as a nonionic surfactant or an anionic surfactant; a pH adjuster; a viscosity modifier such as a thickener; and the like. Here, the thickener is not particularly limited, and examples thereof include sucrose, polyethylene glycol, and polysaccharides such as carboxymethylcellulose and hydroxymethylcellulose.

Further, the catalyst region may contain non-zeolite-based catalyst materials such as a transition metal element-supported ceria-based oxides and/or a ceria-zirconia-based composite oxide as long as the effects of the present invention are not excessively inhibited. When the non-zeolite-based catalyst material is contained, the content thereof is preferably 0.1 to 300 g/L, more preferably 1 to 200 g/L, still more preferably 5 to 100 g/L.

The catalyst region may contain an alkaline earth metal element such as Ca or Mg, and a platinum group element such as rhodium (Rh), ruthenium (Ru), palladium (Pd) or iridium (Ir) or a noble metal element such as gold (Au) or silver (Ag) as a catalytically active component. One of the platinum group elements and noble metal elements can be used, or two or more thereof can be used in any combination and ratio. It is to be noted that preferably, the catalyst region is substantially free of the platinum group element or the noble metal element because it oxidizes an ammonia component to generate NO_{N}. From such a viewpoint, the content of the platinum group element in the catalyst region is preferably less than 3 g/L, more preferably less than 1 g/L. still more preferably less than 0.5 g/L.

The amount of the catalyst region supported per L of the catalyst carrier in the selective reducing catalyst for diesels is not particularly limited, and is preferably 50 g/L or more, more preferably 100 g/L or more, still more preferably 150 g/L or more, from the viewpoint of catalyst performance, etc. The upper limit of the amount of the catalyst region supported is not particularly limited, and is preferably 500 g/L or less, more preferably 400 g/L or less, still more preferably 300 g/L or less, from the viewpoint of pressure loss, etc.

The catalyst region may be placed directly on the integral structure type catalyst carrier, or may be provided on the integral structure type catalyst carrier with a binder layer, an underlayer or the like interposed therebetween. As the binder layer, the underlayer or the like, one known in the art can be used, and the type thereof is not particularly limited. It is possible to use, for example, oxides such as zeolite, cerium oxide (ceria: CeO₂), oxygen storage and release materials (OSC) such as ceria-zirconia composite oxides (CZ composite oxides), aluminum oxides (alumina: Al₂O₃) such as γ-alumina, β-alumina, δ-alumina, η-alumina and θ-alumina, zirconium oxide (zirconia: ZrO₂), silicon oxide (silica: SiO₂) and titanium oxide (titania: TiO₂), and composite oxides containing any of these oxides as a main component. The coating mass of the binder layer, the underlayer or the like per L of the integral structure type catalyst carrier is not particularly limited, and is preferably 1 to 150 g/L, more preferably 10 to 100 g/L.

### (Phosphorus Trapping Region)

The phosphorus trapping region is a region which inhibits phosphorus contained in the exhaust gas from reaching the catalyst region. The phosphorus trapping region contains one or more selected from the group consisting of alumina and rare earth-based basic oxides.

The rare earth element is one or more selected from the group consisting of praseodymium (Pr), lanthanum (La), cerium (Ce) and neodymium (Nd). It is preferable that these elements be supported on an inorganic carrier in the form of an oxide. Of these, CeO₂, Pr₆O₁₁, La₂O₃ and Y₂O₃ are more preferable from the viewpoint of phosphorus trapping performance.

The inorganic carrier is not particularly limited, and examples thereof include inorganic oxides such as alumina (Al₂O₃), titania (TiO₂), silica (SiO₂), zirconia (ZrO₂) and ceria (CeO₂).

The alumina is not particularly limited, and examples thereof include γ-alumina, β-alumina, δ-alumina, η-alumina and θ-alumina. One type of alumina can be used, or two or more types of alumina can be used in any combination and ratio. The alumina is suitable as a phosphorus trapping region because it has little impact on catalyst performance and is stable at high temperatures.

If necessary, the phosphorus trapping region may contain oxides such as zirconium oxide (zirconia: ZrO₂), silicon oxide (silica: SiO₂), titanium oxide (titania: TiO₂), and composite oxides mainly containing any of these oxides as exemplified for base material particles above.

It is preferable that the phosphorus trapping region be substantially free of a zeolite-based catalyst, a composite oxide-based catalyst containing W, a vanadium-based catalyst and a metal element capable of exhibiting catalytic activity which decreases due to phosphorus poisoning. Examples of the metal element capable of exhibiting catalytic activity which decreases due to phosphorus poisoning include platinum group elements. Here, the term “substantially free of” means that the amount of each of the zeolite-based catalyst, the composite oxide-based catalyst, the vanadium-based catalyst and the platinum group element supported per L of the catalyst carrier in the phosphorus trapping region is preferably 0 to 0.1 g/L, more preferably 0 to 0.05 g/L, still more preferably 0 to 0.01 g/L. When the phosphorus trapping region is substantially free of a platinum group element or the like, impacts on the catalyst region tend to be suppressed.

The amount of the phosphorus trapping region supported per L of the catalyst carrier is preferably 20 g/L or more, more preferably 20 to 70 g/L, still more preferably 30 to 60 g/L. When the amount of the phosphorus trapping region supported is 20 g/L or more, deterioration of NOₓ removal performance due to phosphorus poisoning tends to be further suppressed because phosphorus hardly reaches the catalyst region. When the amount of the phosphorus trapping region supported is 70 g/L or less, an increase in pressure loss tends to be further suppressed.

The range over which the phosphorus trapping region is formed is not particularly limited, and the phosphorus trapping region may be formed over the entire catalyst carrier in the exhaust gas flow direction, or may be formed on some regions of the catalyst carrier in the exhaust gas flow direction. When the phosphorus trapping region is formed on some regions of the catalyst carrier in the exhaust gas flow direction, it is preferable that the phosphorus trapping region be formed on the upstream side of the catalyst carrier in the exhaust gas flow direction. Further, it is preferable that the phosphorus trapping region be formed with a larger thickness on the upstream side of the catalyst carrier in the exhaust gas flow direction.

From the viewpoint of suppression of peeling and exhaust gas purification performance of the SCR catalyst (layer), the average particle diameter D₅₀ of the particles of alumina or the like forming the phosphorus trapping region is preferably 0.1 μm to 100 μm, more preferably 1.0 μm to 30 μm, still more preferably 3.0 μm to 20 μm. When the average particle diameter D₅₀ is 100 μm or less, deterioration of NOₓ purification performance due to phosphorus poisoning tends to be further suppressed because the specific surface area of the phosphorus trapping region increases, so that phosphorus hardly reaches the catalyst region. When the average particle diameter D₅₀ is 1.0 μm or more, an increase in pressure loss tends to be further suppressed because the space between aluminas expands.

From the same viewpoint, the particle diameter D₉₀ of the particles of alumina or the like forming the phosphorus trapping region is preferably 5.0 μm to 35 μm, more preferably 8.0 μm to 30 μm, still more preferably 12 μm to 25 μm. When the particle diameter D₉₀ is 35 μm or less, deterioration of NOₓ purification performance due to phosphorus poisoning tends to be further suppressed because the specific surface area of the phosphorus trapping region increases, so that phosphorus hardly reaches the catalyst region. When the particle diameter D₉₀ is 5.0 μm or more, an increase in pressure loss tends to be further suppressed because the space between aluminas expands. The term “particle diameter D₀₀” refers to a particle diameter at which the integrated value at smaller particle diameters reaches 90% of the total in a cumulative distribution of particle diameters on a volume basis.

The phosphorus trapping region may contain various other catalyst materials and co-catalyst known in the art and various additives. The phosphorus trapping region may contain binders such as a variety of sols such as, for example, boehmite, alumina sol, titania sol, silica sol and zirconia sol; and soluble salts such as aluminum nitrate, aluminum acetate, titanium nitrate, titanium acetate, zirconium nitrate and zirconium acetate. The catalyst region may further contain a Ba-containing compound in addition to the above-described components. Further, the catalyst region may contain a dispersion stabilizer such as a nonionic surfactant or an anionic surfactant; a pH adjuster; a viscosity modifier such as a thickener; and the like.

Here, the thickener is not particularly limited, and examples thereof include sucrose, polyethylene glycol, and polysaccharides such as carboxymethylcellulose and hydroxymethylcellulose.

### [Diesel Exhaust Gas Purification Apparatus]

In the diesel exhaust gas purification apparatus according to the present embodiment, the selective reducing catalyst for diesels is provided on the upstream side and the oxidation catalyst is provided on the downstream side so that the exhaust gas contacts the selective reducing catalyst and the oxidation catalyst in this order.

FIG. 1 shows an aspect of the diesel exhaust gas purification apparatus comprising the selective reducing catalyst for diesels (cc-SCR catalyst) according to the present embodiment. In FIG. 1, the diesel exhaust gas purification apparatus 100 further comprises the selective reducing catalyst for diesels (cc-SCR catalyst) arranged immediately below the diesel engine EG in the configuration of a conventional purification apparatus comprising an oxidation catalyst (DOC), a selective reducing catalyst (SCR catalyst), an ammonia oxidation catalyst (AMOX) and the like.

### (Oxidation Catalyst)

The oxidation catalyst is a catalyst which oxidizes CO, HC, NO, NH₃ and the like in the exhaust gas. In the present description, the oxidation catalyst conceptually includes a lean NOₓ storage catalyst (LNT, lean NOₓ trap) which stores NOₓ under a lean condition and releases NOₓ under a rich condition to oxidize CO and HC to CO₂ and H₂O and reduce NOₓ to N₂, and catalyst-coated PF (cPF) obtained by applying such a catalyst onto PF. As the oxidation catalyst in the diesel exhaust gas purification apparatus 100, composite particles including base material particles of metal oxides such as alumina, zirconia and ceria and zeolite and platinum group metals (PGMs) as catalytically active components supported on such carriers are generally used. These are known in the art in a variety of kinds, and as the oxidation catalyst, one of the various oxidation catalysts can be used, or two or more thereof can be appropriately combined and used in any combination.

As the oxidation catalyst, catalysts are preferably used in which a catalyst layer including base material particles that are inorganic particulates and a platinum group element-supported catalyst material with a platinum group element supported on the base material particles is provided on an integral structure type catalyst carrier such as a honeycomb structure. By forming the oxidation catalyst using such a platinum group element-supported catalyst material, high exhaust gas purification performance can be achieved while an increase in pressure loss is inhibited.

Here, as the inorganic particulates as base material particles supporting a platinum group element, an inorganic compound heretofore used in this type of exhaust gas purifying catalysts can be considered. Examples thereof include oxides, such as zeolite, cerium oxide (ceria: CeO₂), oxygen storage and release materials (OSC), such as ceria-zirconia composite oxides (CZ composite oxides), aluminum oxides (alumina: Al₂O₃), such as γ-alumina, β-alumina, δ-alumina, η-alumina and θ-alumina, zirconium oxide (zirconia: ZrO₂), silicon oxide (silica: SiO₂) and titanium oxide (titania: TiO₂), and composite oxides containing any of these oxides as a main component, and the type thereof is not particularly limited. They may be composite oxides or solid solutions containing a rare earth element such as lanthanum or yttrium, a transition metal element or an alkaline earth metal. One of these inorganic particulates can be used, or two or more thereof can be used in any combination and ratio. The oxygen storage and release material means a material which stores or releases oxygen depending on an external environment.

The average particle diameter D₅₀ of the base material particles of the oxidation catalyst can be appropriately set depending on desired performance, and is not particularly limited. From the viewpoint of maintaining a large specific surface area and enhancing heat resistance to increase the number of their own catalytically active sites, the average particle diameter D₅₀ of the base material particles is preferably 0.5 to 100 μm, more preferably 1 to 100 μm, still more preferably 1 to 50 μm. The BET specific surface area of the base material particles can be appropriately set depending on desired performance, and is not particularly limited, and from the viewpoint of maintaining a large specific surface area and enhancing catalytic activity, the BET specific surface area by the BET one-point method is preferably 10 to 500 m²/g, more preferably 20 to 300 m²/g, still more preferably 30 to 200 m²/g. As various materials to be used as the base material particles of the oxidation catalyst, a large number of materials of various grades are commercially available from domestic and foreign manufacturers, and depending on required performance, commercial products of various grades can be used as the base material particles. The base material particles can also be produced by methods known in the art.

Examples of the platinum group element include platinum (Pt), palladium (Pd), rhodium (Rh), ruthenium (Ru), iridium (Ir) and osmium (Os). One of the platinum group elements can be used, or two or more thereof can be used in any combination and ratio. From the viewpoint of improving the exhaust gas purification performance, suppressing advancement of grain growth (sintering) of the platinum group element on the base material particles, etc., the content ratio of the platinum group element in the oxidation catalyst (mass of the platinum group element per L of the integral structure type catalyst carrier) is, normally, preferably 0.1 to 20 g/L, more preferably 0.2 to 15 g/L, still more preferably 0.3 to 10 g/L.

The oxidation catalyst may contain various other catalyst materials and co-catalyst known in the art and various additives. The oxidation catalyst may contain binders such as a variety of sols such as, for example, boehmite, alumina sol, titania sol, silica sol and zirconia sol; and soluble salts such as aluminum nitrate, aluminum acetate, titanium nitrate, titanium acetate, zirconium nitrate and zirconium acetate. The oxidation catalyst may further contain a Ba-containing compound in addition to the above-described components. By adding a Ba-containing compound, improvement of heat resistance, and activation of catalyst performance can be expected. Examples of the Ba-containing compound include, but are not particularly limited to, sulfates, carbonates, composite oxides and oxides. More specific examples thereof include BaO, Ba(CH₃COO)₂, BaO₂, BaSO₄, BaCO₃, BaZrO₃ and BaAl₂O₄. Further, the oxidation catalyst may contain a dispersion stabilizer, such as a nonionic surfactant or an anionic surfactant; a pH adjuster; a viscosity modifier, such as a thickener; and the like.

As the integral structure type catalyst carrier supporting the oxidation catalyst, honeycomb structures commonly used for automobile exhaust gas applications are preferably used. Specific examples of the honeycomb structure are as described above, and therefore omitted here to avoid redundancy. As the honeycomb structure supporting the second catalyst region, both of a flow-through type structure and a wall flow type structure are applicable.

In the above-described oxidation catalyst, the total coverage of the above-described catalyst layer is not particularly limited, and from the viewpoint of the balance between catalyst performance and pressure loss, etc., from the viewpoint of the balance between catalyst performance and pressure loss, etc., the total coverage per L of the integral structure type catalyst carrier is preferably 1 to 500 g/L, more preferably 5 to 450 g/L, still more preferably 5 to 80 g/L for the wall flow type catalyst carrier and 200 to 450 g/L for the flow-through type catalyst carrier.

The catalyst layer of the oxidation catalyst can be used as a single layer, or can be used as a laminate with two or more layers depending on required performance. Further, the catalyst layer may be directly placed on the catalyst layer integral structure type catalyst carrier of the oxidation catalyst, or may be provided on the integral structure type catalyst carrier with a binder layer, an underlayer or the like interposed therebetween. As the binder layer, the underlayer or the like, one known in the art can be used, and the type thereof is not particularly limited. It is possible to use oxides, such as zeolite, cerium oxide (ceria: CeO₂), oxygen storage and release materials (OSC) such as ceria-zirconia composite oxides (CZ composite oxides), aluminum oxides (alumina: Al₂O₃), such as γ-alumina, β-alumina, δ-alumina, η-alumina and θ-alumina, zirconium oxide (zirconia: ZrO₂), silicon oxide (silica: SiO₂) and titanium oxide (titania: TiO₂), and composite oxides containing any of these oxides as a main component. The coating mass of the binder layer, the underlayer or the like is not particularly limited, and is preferably 1 to 150 g per L, more preferably 10 to 100 g per L of the integral structure type catalyst carrier.

The number of the oxidation catalysts provided in the system of the exhaust gas flow channel of the diesel exhaust gas purification apparatus 100 according to the present embodiment may be at least one, or may be two or more (e.g. two to five) depending on required performance etc. It is also possible to use a zone-coated oxidation catalyst obtained by zone-coating one catalyst carrier with two oxidation catalyst materials. When a plurality of oxidation catalysts is provided, the oxidation catalysts may be the same type of DOC, or different types of DOC.

When a plurality of oxidation catalyst is provided in the system of the exhaust gas channel of the diesel exhaust gas purification apparatus 100 according to the present embodiment, the oxidation catalysts may be arranged adjacently, or arranged separately in the exhaust gas flow channel with the selective reducing catalyst, the reducing agent supplying unit, the heating device, the plasma generating apparatus or the like interposed therebetween.

### (Selective Reducing Catalyst (SCR Catalyst))

Examples of the selective reducing catalyst include selective reducing catalysts having the same configuration as that of the above-described selective reducing catalyst for diesels except that the phosphorus trapping region is not present.

The number of selective reducing catalysts provided in the system of the exhaust gas flow channel of the diesel exhaust gas purification apparatus 100 according to the present embodiment may be at least one, or may be two or more (e.g. two to five) depending on required performance, etc.

### (Reducing Agent Supplying Unit Red.)

In the diesel exhaust gas purification apparatus 100 according to the present embodiment, the reducing agent supplying unit Red. supplies one or more reducing agents selected from a urea component and an ammonia component into the exhaust gas flow channel. As the reducing agent supplying unit Red., one known in the art can be used, and the type thereof is not particularly limited. Normally, one composed of a reducing agent storage tank, a pipe connected to the tank, and a spray nozzle mounted at the tip of the pipe is used (not shown).

The spray nozzle of the reducing agent supplying unit Red. is placed at a position on the upstream side of the above-described selective reducing catalyst. When the diesel exhaust gas purification apparatus 100 has a plurality of selective reducing catalyst as in FIG. 1, it is possible to provide the reducing agent supplying unit Red. on the upstream side of each of the selective reducing catalyst for diesels and the selective reducing catalyst. When other selective reducing catalysts are used in combination, spray nozzles of the reducing agent supplying unit Red. may be provided at a plurality of points in the case where these catalysts are arranged separately.

The reducing component is selected from a urea component and an ammonia component. As the urea component, a standardized aqueous urea solution at a concentration of 31.8 to 33.3 wt %, such as, for example, Adblue (product name) can be used. As the ammonia component, aqueous ammonia as well as ammonia gas or the like can be used. Since NH₃ which is a reducing component itself has harmful properties such as an irritating odor, a method is preferable in which rather than directly using NH₃ as a reducing component, aqueous urea is added from the upstream side of the selective reducing catalyst to generate NH₃ through thermal decomposition or hydrolysis, and the NH₃ is applied as the reducing agent.

### (Heating Device (Heater))

In the diesel exhaust gas purification apparatus 100 according to the present embodiment, an electric heating device (Heater) (catalyst heating device) is provided in the exhaust gas flow channel on the downstream side of the spray nozzle of the reducing agent supplying unit Red. and on the upstream side of the selective reducing catalyst. The heating device is electrically connected to ECU and an on-vehicle power supply (not shown), and by controlling the power outputs of the ECU and the power supply, the temperature of the heating device (Heater), and hence the temperature of the exhaust gas in the exhaust gas flow channel can be controlled. One or more reducing agents selected from the group consisting of a urea component and an ammonia component and supplied from the reducing agent supplying unit Red. are heated with the heating device (Heater) in the exhaust gas flow channel to turn into NH₃ through thermal decomposition or hydrolysis, and adsorbed to the selective reducing catalyst on the downstream side of the exhaust gas flow channel. The reactivity of urea in the hydrolysis reaction can vary depending on the concentration, the combination composition, the pH and the like of aqueous urea, and can be efficiently controlled by controlling the temperature of the exhaust gas in the exhaust gas flow channel. In the exhaust gas flow channel, temperature sensors, NOₓ sensors and the like electrically connected to ECU are provided at various points, so that the NOₓ concentration and the exhaust gas temperature are monitored as needed.

In the present embodiment, the heating device (Heater) is composed of a metal honeycomb, a jacket type electric heating device mounted on the outer periphery of the metal honeycomb, and a coil type electric heating device mounted so as to be partially embedded in the metal honeycomb main body (not shown). This metal honeycomb can be electrically heated by control of the control unit ECU, and by heat generation from the metal honeycomb, the temperature of the exhaust gas passing through the exhaust gas flow channel can be controlled. In the present embodiment, a heat insulating material is provided on the outer periphery of an exhaust channel over the entire length (not shown). The heat insulating material is not particularly limited, and can be appropriately selected from those known in the art, and for example, one obtained using cellulose fibers, rock wool or the like is suitably used. The heating device (Heater) used here may be, for example, a jacket type electric heating device or an electrically heated catalyst (EHC) with a SCR catalyst supported on the metal honeycomb main body. Heating of the metal honeycomb can also be performed by causing the metal honeycomb itself to generate heat directly with an electric current passing through the metal honeycomb main body. In this case, by connecting the metal honeycomb to an on-vehicle power supply and controlling the power output of the power supply by the control unit ECU, the temperature of the metal honeycomb, and hence the temperature of the exhaust gas in the exhaust flow channel can be controlled.

### (Ammonia Oxidation Catalyst AMOX)

In the diesel exhaust gas purification apparatus 100 according to the present embodiment, an ammonia oxidation catalyst AMOX which oxidizes and removes excess ammonia is provided on the downstream side of the selective reducing catalyst. As the ammonia oxidation catalyst AMOX, one known in the art can be used, and the type thereof is not particularly limited.

Normally, in a urea SCR system, the ammonia oxidation catalyst AMOX is additionally used if NOₓ or NH₃ cannot be purified to a regulatory value or a smaller value. Therefore, the ammonia oxidation catalyst AMOX includes a catalyst having a function of oxidizing NH₃, and a catalyst component having a function of purifying NOₓ. The catalyst having a function of oxidizing NH₃ is preferably one in which one or more elements selected from platinum, palladium, rhodium and the like are supported on an inorganic material composed of one or more selected from alumina, silica, titania, zirconia and the like. It is also preferable to use an inorganic material whose heat resistance is improved by adding a co-catalyst such as a rare earth, an alkali metal or an alkaline earth metal. Platinum and palladium as noble metals exhibit excellent oxidative activity. When the noble metal is supported on the inorganic material having a high specific surface area and high heat resistance, the noble metal component is hardly sintered, and thus the specific surface area of the noble metal is kept high to increase the number of active sites, so that high activity can be exhibited. On the other hand, as the catalyst having a function of purifying NOₓ, all of the non-zeolite-based catalyst materials and the zeolite-based catalyst materials described in the paragraph of “Selective reducing catalyst” can be used. The two types of catalysts may be uniformly mixed and applied to a honeycomb structure of integral type, but may be applied such that a catalyst having a function of oxidizing NH₃ forms a lower layer and a catalyst having a function of purifying NOₓ forms an upper layer. The volumes (sizes) of the ammonia oxidation catalyst AMOX, the coating mass of catalyst material, and the like are not particularly limited, and can be adjusted with consideration given to the type, the displacement and the like of an engine to which the exhaust gas purification apparatus 100 for lean combustion engines according to the present embodiment is applied, and depending on the required catalyst amount, purification performance and the like.

Two or more (two to five) ammonia oxidation catalysts AMOX described above may be provided depending on required performance or the like. The ammonia oxidation catalyst AMOX can also be used as zone-coated AMOX (zAMOX) by zone-coating one catalyst carrier with two catalyst materials. When a plurality of ammonia oxidation catalysts AMOX is provided, the arrangement state of the ammonia oxidation catalysts AMOX is not particularly limited. That is, a plurality of ammonia oxidation catalysts AMOX may be arranged adjacently or arranged separately. From the viewpoint of oxidizing and removing excess ammonia, it is preferable that at least one of a plurality of ammonia oxidation catalysts AMOX be provided on the downstream side of the selective reducing catalyst, and more preferably provided at the most downstream in the exhaust gas flow channel preferably containing the oxidation catalyst and the selective reducing catalyst.

### EXAMPLES

Hereinafter, the feature of the present invention will be described more specifically by way of Test Examples, Examples and Comparable Example, but the present invention is not in any way limited by these Examples. That is, the materials, the use amounts, the ratios, the treatment details, the treatment procedures and the like shown in Examples below can be appropriately changed without departing from the spirit of the present invention. The values of various production conditions and evaluation results in Examples below have the meaning as preferred upper limit values or preferred lower limit values in the embodiment of the present invention, and the preferred range may be a range defined by a combination of the above-mentioned upper limit or lower limit value and a value in Example or Examples below.

### Example 1

Cu-SSZ-13 (SAR: 18, contained at 5 mass % in terms of CuO), an alumina binder, a surfactant and deionized water were mixed, and the mixture was milled with a ball mill to obtain a slurry. By a wash coating method, the slurry was applied to a honeycomb flow-through type cordierite carrier (300 cpsi/5 mil, 266.7 mm (diameter)×76.2 mm (length)) which is an integral structure type catalyst carrier. Here, the content of a catalyst region per L of the catalyst carrier was 165 g/L. Thereafter, drying was carried out, followed by performing firing in an air atmosphere at 550° C. for 30 minutes to form the catalyst region.

Subsequently, alumina powder (average particle diameter D₅₀: 60 μm), water, acetic acid and a thickener were added in the ball mill, and the mixture was milled to a particle diameter D₉₀ of 16 to 20 μm and a particle diameter D₅₀ of 4.5 to 7.5 μm to obtain a slurry. Subsequently, the slurry was applied by the wash coating method so as to cover the catalyst region on the catalyst carrier. Here, the content of a phosphorus trapping region per L of the catalyst carrier was 20 g/L. Thereafter, drying was carried out, followed by performing firing in an air atmosphere at 550° C. for 30 minutes to form the phosphorus trapping region on the catalyst region.

A converter was packed with the obtained selective reducing catalyst for diesels, and connected to an exhaust outlet of a diesel engine (displacement: 8 L).

### Example 2

Except that the phosphorus trapping region per L of the catalyst carrier was 35 g/L, the same procedure as described above was carried out to obtain a selective reducing catalyst for diesels.

### Example 3

Except that the phosphorus trapping region per L of the catalyst carrier was 50 g/L, the same procedure as described above was carried out to obtain a selective reducing catalyst for diesels.

### Comparative Example 1

Except that a phosphorus trapping region was not formed, the same procedure as described above was carried out to obtain a selective reducing catalyst for diesels.

### (Measurement of Pressure Loss)

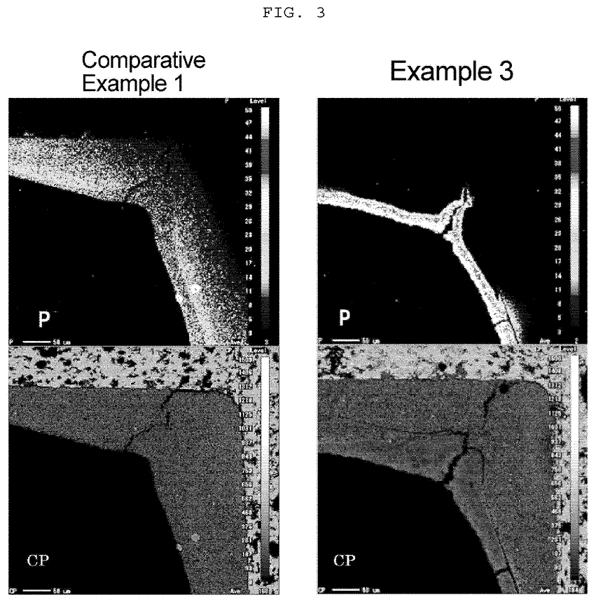

Using an air flow measurement apparatus (SF-1020, SuperFlow Company), the pressure loss was measured by causing air at a space velocity of 415,000 h⁻¹ to pass through the selective reducing catalyst for diesels. The space velocity means the volume of an exhaust gas passing through the unit volume of the honeycomb structure for an hour. FIG. 2 shows the results.

### (Phosphorus Poisoning Treatment)

The selective reducing catalyst for diesels was placed immediately below the diesel engine, and a phosphorus supplying unit for spraying an aqueous solution containing phosphorus was provided on a pipe connecting the diesel engine to the selective reducing catalyst for diesels. The rated operation of the diesel engine was performed at 2500 rpm, and as the aqueous solution containing phosphorus, an aqueous solution of a phosphonic acid amine salt (manufactured by SAN NOPCO LIMITED, SN Dispersant 2060) was sprayed in a direction opposite to the flow of the gas. By adjusting the spraying time, the amount of phosphorus poisoning of the selective reducing catalyst for diesels was adjusted.

### (NOₓ Removal Performance)

The selective reducing catalyst for diesels, which had been subjected to phosphorus poisoning for 20 hours as described above, was placed immediately below the diesel engine, and a urea supplying unit for spraying urea was provided on the pipe connecting the diesel engine to the selective reducing catalyst for diesels. The rated operation of the diesel engine was performed at 2500 rpm, and the temperature of an inlet for the selective reducing catalyst for diesels was adjusted to 200° C. Thereafter, the warming-up operation of the diesel engine was performed, and an equimolar amount of urea was sprayed to NOₓ reaching the inlet for the selective reducing catalyst for diesels. Two hours after spraying of the urea was started, the amount of NOₓ supplied to the selective reducing catalyst for diesels and the amount of NOₓ discharged from the selective reducing catalyst for diesels were measured, and the NOₓ removal rate was calculated.

In the same manner as described above, a similar test was conducted on the selective reducing catalyst for diesels which had been subjected to phosphorus poisoning treatment for 40 hours and the selective reducing catalyst for diesels which had not been subjected to phosphorus poisoning, and the NOₓ removal rate was calculated.

The NOₓ removal rate in the selective reducing catalyst for diesels which had not been subjected to phosphorus poisoning was defined as a reference value (100), and the NOₓ removal rate in the selective reducing catalyst for diesels which had been subjected to phosphorus poisoning treatment for 20 hours and the NOₓ removal rate in the selective reducing catalyst for diesels which had been subjected to phosphorus poisoning treatment for 40 hours were determined as a relative value against the reference value. The decline from the reference value (100) can be taken as a rate of decrease in NOₓ removal rate when the catalyst is poisoned. The results are shown below.

TABLE 1

| | Rate of decrease in NO_{×} removal rate | | |
|---|---|---|---|
| | Before | | |
| | phosphorus | After phosphorus poisoning | |
| | poisoning | 20 hours | 40 hours |
| Comparative | 100 | 85 | 79 |
| Example 1 | | | |
| Example 1 | 100 | 89 | 81 |
| Example 2 | 100 | 93 | 83 |
| Example 3 | 100 | 98 | 89 |

### [Observation of Phosphorus-Poisoned State]

The selective reducing catalyst for diesels which had been prepared in Example 3 was subjected to phosphorus poisoning treatment for 20 hours, and a measurement sample (1 cm³) for electron probe microanalyzer analysis (EPMA) was then prepared from a cross-section of a partition wall. The measurement sample was embedded in resin, and carbon vapor deposition was performed as pretreatment. The measurement sample after the pretreatment was observed with an electron probe microanalyzer analysis apparatus (manufactured by JEOL Ltd., trade name: JXA-8230) to examine the phosphorus-poisoned state.

Similarly, the selective reducing catalyst for diesels which had been prepared in Comparative Example 1 was subjected to phosphorus poisoning for 20 hours, and a cross-section of a partition wall was observed with the electron probe microanalyzer analysis apparatus (manufactured by JEOL Ltd., trade name: JXA-8230) to examine the phosphorus-poisoned state.

FIG. 3 shows the results. As shown in FIG. 3, phosphorus does not reach the catalyst region in Example 3 where the phosphorus trapping region is present, whereas phosphorus reaches the entire catalyst region in Comparative Example 3 where the phosphorus trapping region is not present.

### INDUSTRIAL APPLICABILITY

The selective reducing catalyst of the present invention has industrial applicability as a selective reducing catalyst arranged in a diesel engine.

### REFERENCE SIGNS LIST

100 Exhaust gas purification apparatus for lean combustion engine
EG Engine
cc-SCR catalyst Selective reducing catalyst for diesels
cc-AMOX, AMOX Ammonia oxidation catalyst
DOC oxidation catalyst (diesel oxidation catalyst)
CSF Catalyzed soot filter
SCR catalyst Selective reducing catalyst

1. A selective reducing catalyst for diesels which is arranged in a diesel engine, adsorbs ammonia,_ and brings the ammonia into contact with nitrogen oxides in an exhaust gas discharged from a diesel engine to perform reduction, the selective reducing catalyst comprising:
a catalyst carrier;
a catalyst region provided on at least the catalyst carrier; and
a phosphorus trapping region provided on at least the catalyst region,
wherein the catalyst region comprises one or more selected from the group consisting of a zeolite-based catalyst containing at least a zeolite and a transition metal element supported on the zeolite, a composite oxide-based catalyst containing W, and a vanadium-based catalyst, and
wherein the phosphorus trapping region comprises at least one or more selected from the group consisting of alumina and a rare earth-based basic oxide.

2. The selective reducing catalyst for diesels according to claim 1,
wherein the phosphorus trapping region is substantially free of a platinum element.

3. The selective reducing catalyst for diesels according to claim 1,
wherein the amount of the phosphorus trapping region supported per L of the catalyst carrier is 20 g/L or more.

4. The selective reducing catalyst for diesels according to claim 1,
wherein the phosphorus trapping region comprises particles having a particle diameter D₉₀ of 5.0 μm to 35 μm.

5. The selective reducing catalyst for diesels according to claim 1,
wherein the transition metal element comprises at least one or more selected from the group consisting of Cu, Fe, Ce, Mn, Ni, Co, Ag, Rh, Ru, Pd, Ir, and Re.

6. The selective reducing catalyst for diesels according to claim 1,
wherein the zeolite having has at least one structure selected from the group consisting of an oxygen six-membered ring structure, an oxygen double six-membered ring structure, an oxygen eight-membered ring structure, and an oxygen twelve-membered ring structure.

7. The selective reducing catalyst for diesels according to claim 1,
wherein the zeolite is one or more selected from the group consisting of CHA, AFX, KFI, SFW, MFI, and BEA.

8. The selective reducing catalyst for diesels according to claim 1,
wherein the catalyst carrier is a flow-through type catalyst carrier.

9. The selective reducing catalyst for diesels according to claim 1,
wherein the amount of the catalyst region supported per L of the catalyst carrier is 100 g/L or more.

10. A diesel exhaust gas purification apparatus, comprising:
a selective reducing catalyst which adsorbs ammonia and brings the ammonia into contact with nitrogen oxides in an exhaust gas discharged from a diesel engine to perform reduction; and
one or more oxidation catalysts which oxidize, discharged from the diesel engine, at least one selected from the group consisting of CO, HC, NO, and NH₃,
wherein the selective reducing catalyst is a selective reducing catalyst for diesels according to claim 1, and
the selective reducing catalyst is arranged on the upstream side of the exhaust gas flow channel with respect to the oxidation catalyst so that the exhaust gas contacts the selective reducing catalyst and the oxidation catalyst in this order.
